(19) United States
(12) Patent Application Publication
(10) Pub. No.: US 2012/0031926 A1
(43) Pub. Date: Feb. 9, 2012

(54) Delivery Device for Fluid Products and Relative Delivery Method

(75) Inventors: Mirko Bertoli, Medolla (IT); Roberto Avanzi, Finale Emilia (IT); Anna Guerra, Mirandola (IT); Michele Abelli, Bomporto (IT)

(73) Assignee: CPS COLOR EQUIPMENT SPA CON UNICO SOCIO, San Felice Sul Panaro (IT)

(21) Appl. No.: 13/262,229

(22) PCT Filed: Mar. 26, 2010
(86) PCT No.: PCT/IB2010/000680

§ 371 Date: Sep. 29, 2011

(30) Foreign Application Priority Data
Mar. 30, 2009 (IT) UD2009A000063

(51) Int. Cl. B67D 7/78; B67D 7/06

(52) U.S. Cl. 222/144; 222/144.5

(57) ABSTRACT

A delivery device for fluid products including a plurality of containers, to contain a predetermined fluid and connected to an associated delivery unit provided with a piston unit. The device also includes a support on which the containers are mounted. The support rotates to position sequentially, at different moments of time according to one or more predetermined sequences, at least some of the delivery units in a predetermined delivery seating, to deliver corresponding quantities of fluid to obtain a desired fluid composition. Each delivery unit is provided with at least a disk type delivery valve, able to be activated between at least two distinct open conditions and a closed condition.

### FIELD OF THE INVENTION

The present invention concerns a delivery device for fluid products, semi-fluids, pastes, gels or creams, such as for example coloring products, food products or other, and the relative delivery method.

In particular, the delivery device according to the present invention is suitable for the selective delivery of fluid products such as colorants of different shades or color, creams of different flavor or other, able to be dosed and/or added to a base substance so as to form a paint or varnish or other fluid product, of a determinate color or flavor.

### BACKGROUND OF THE INVENTION

Devices are known for dispensing fluid products, semi-fluids, pastes, gels or creams, such as for example coloring products, food products or other. Known dispenser devices comprise a plurality of containers or canisters, each suitable to contain a predetermined fluid, colorant or food product, and connected to an associated delivery unit, such as for example a piston pump or bellows pump.

The canisters and the associated delivery units are mounted on a rotating table suitable to rotate so as to position the delivery units, according to a predetermined sequence, in correspondence with a delivery position. In the delivery position, a specific delivery unit is able to dispense, in the desired quantity, the fluid of the corresponding container toward an outlet container, allowing to fill it with one or more of said fluids so as to obtain a fluid with a desired composition and/or formula.

Each delivery unit is provided with a nozzle with which a valve is associated, normally of the ball type, provided with a through pipe. The ball valve is mobile between a closed position, in which it is disposed with the through pipe substantially transverse inside the nozzle, to prevent the fluid leaking from the nozzle. The ball valve is also mobile to at least an open position, in which it is rotated so as to align its through pipe with the nozzle, therefore allowing the fluid to pass and be delivered.

One disadvantage of the known delivery device is that, despite the fact that at least part of the fluid present in the pipe of the ball valve is in contact with the fluid present in the nozzle, part of said fluid can dry out, which causes an obstruction of the pipe of the ball valve, especially in the event of a prolonged non-use of the corresponding delivery unit. This entails the need for frequent maintenance interventions, with consequent and extended downtimes of the machine.

One purpose of the present invention is to achieve a delivery unit for fluid products that allows a selective delivery, in the desired quantities, of one or more fluid products, minimizing the maintenance times and interventions.

Another purpose is to perfect a dispensing method which allows to selectively deliver, with the maximum dosing accuracy, one or more fluid products in the desired quantities, even minimal.

The Applicant has devised, tested and embodied the present invention to overcome the shortcomings of the state of the art and to obtain, these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a delivery device for fluid products according to the present invention is suitable to dispense or deliver fluid products, semi-fluids, pastes, gels or creams such as for example coloring products, food products or other.

The delivery device comprises a plurality of containers or canisters, each suitable to contain a predetermined fluid, colorant or food product, and connected to an associated delivery unit and comprising a corresponding piston unit or piston pump.

The delivery device also comprises a rotary support on which said plurality of containers is mounted. The support rotates so as to position sequentially, at different moments of time and according to one or more predetermined sequences, at least part of the delivery units in a corresponding delivery position, so as to deliver predetermined quantities of fluid into an outlet container so as to obtain a final product with a desired final composition and/or formula.

According to a characteristic feature of the present invention, each delivery unit is provided with at least a delivery valve of the disk type, able to be activated between at least two different open conditions and a closed condition.

According to a variant, the device also comprises first actuation means and second actuation means able to cooperate with each of said delivery units when the selected delivery unit is disposed, by selective rotation of the rotary support, in the delivery position, in order to drive respectively the corresponding piston unit and the associated delivery valve between the specific open condition and the closed condition.

According to a variant of the present invention, the disk type delivery valve is made of ceramic material.

According to a variant of the present invention, the first actuation means are able to assume an inactive position in which they do not interfere mechanically with the delivery valve during the rotation of the support.

A variant of the present invention provides that said rotary support is moved in opposite directions of rotation so as to position in succession, according to the pre-established delivery sequences, said delivery units in the delivery position so as to minimize the overall travel of the support during the delivery sequence.

According to another variant of the present invention, the device comprises stirrer means, associated with the containers and able to mix the fluids contained in the containers. At least some of the stirrer means in each container are able to be selectively activated, independently of each other, so as to keep the corresponding fluid contained in optimum conditions to allow an efficient delivery thereof.

According to another variant the stirrer means are able to be selectively activated independently of the movement of the rotary support and/or its direction of rotation.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a perspective view of a delivery device according to the present invention;

FIG. 1A is a schematic view from above of a detail of the delivery device in FIG. 1;

FIG. 1B is a block diagram of the delivery device in FIG. 1;

FIG. 1C is a schematic view from above of the delivery device in FIG. 1;

FIG. 2 is a three-dimensional view of a delivery unit of the device in FIG. 1;

FIG. 3 is a front view of the delivery unit in FIG. 2;

FIG. 4 is a section view from IV to IV of FIG. 3;

FIG. 5 is a lateral view of the delivery unit in FIG. 2;

FIG. 5A is a view from above of the delivery unit in FIG. 2;

FIG. 5B is a view from below of the delivery device in FIG. 2;

FIG. 6 is a three-dimensional view of a first actuation unit of the device in FIG. 1;

FIGS. 6A-6C are views respectively from below, the side and the front of the actuation unit in FIG. 6;

FIGS. 7A-7B are perspective views of a second actuation unit of the device in FIG. 1;

FIGS. 8A-8D are lateral views of some delivery steps of the device in FIG. 1;

FIG. 9 is a partly sectioned lateral view of a first detail of the device in FIG. 1;

FIG. 10 is a partly sectioned lateral view of a container of the delivery device in FIG. 1;

FIG. 10A is a three-dimensional view of the container in FIG. 4.

### DETAILED DESCRIPTION OF A PREFERENTIAL FORM OF EMBODIMENT

With reference to the attached drawings, a delivery device 10 according to the present invention comprises a support frame 12, a rotary table 13, a plurality of containers or canisters 16, associated with an equal number of dosing circuits or delivery units 21, provided with pistons 21a, a delivery valve 30 and an actuation unit 40, able to cooperate with each dosing circuit 21. The device 10 also comprises a control board 50, comprising a control and processing unit 51. The delivery device 10 is also advantageously provided with a box-like containing casing, not shown in the drawings.

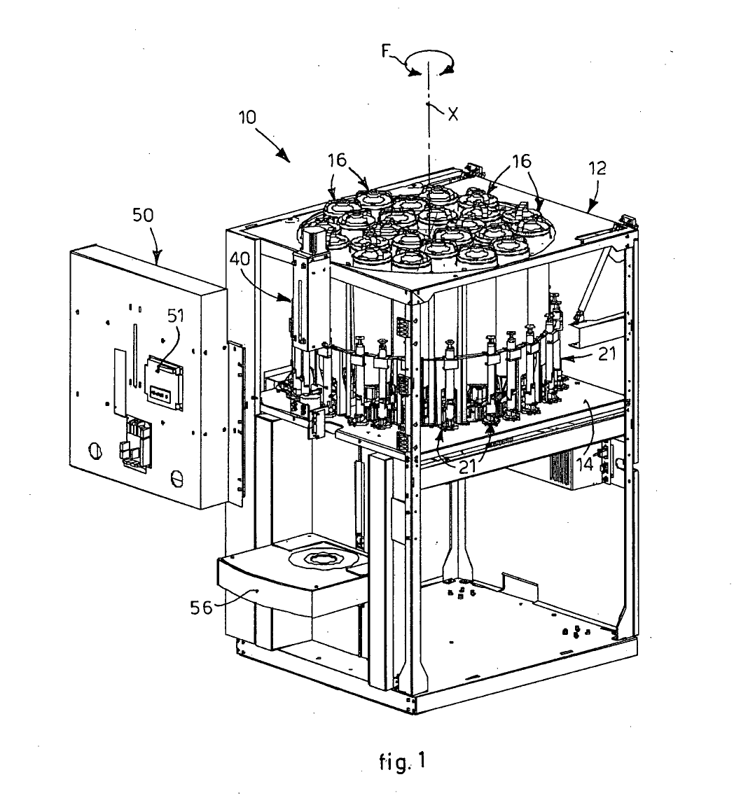

The rotary table 13, substantially of a circular shape (FIGS. 1 and 1A), is attached in a known manner to a horizontal shelf 14 of the frame 12 and is movable in two opposite directions of rotation, as indicated by the arrow F, around an axis of rotation X orthogonal to the table 13. The canisters 16 containing the colorants are disposed on the upper surface of the table 13, according to a predetermined disposition. In this case there are twenty four dosing circuits 21, and twenty four canisters 16. The dosing circuits 21, each of which is connected to a corresponding canister 16 by means of a pipe 17 to feed the colorant, are disposed on a peripheral edge of the table 13 so as to be distributed substantially regularly along its whole circumference.

The rotation of the table 13 is achieved by means of motor means of a known type, for example by means of a direct current motor 19, which is commanded by the control and processing unit 51, in coordination with one or more specific delivery sequences. The motor can possibly be associated with one or more motor reducer devices. It is understood that the table 13 can be moved by means of a step motor, a brushless motor, a linear motor or by another type of suitable motor.

The device 10 also comprises a dispensing seating having a tray 56 disposed on a front of the frame 12 in which a container can be positioned, into which the colorants are delivered, according to said sequences and as will be described in more detail hereafter.

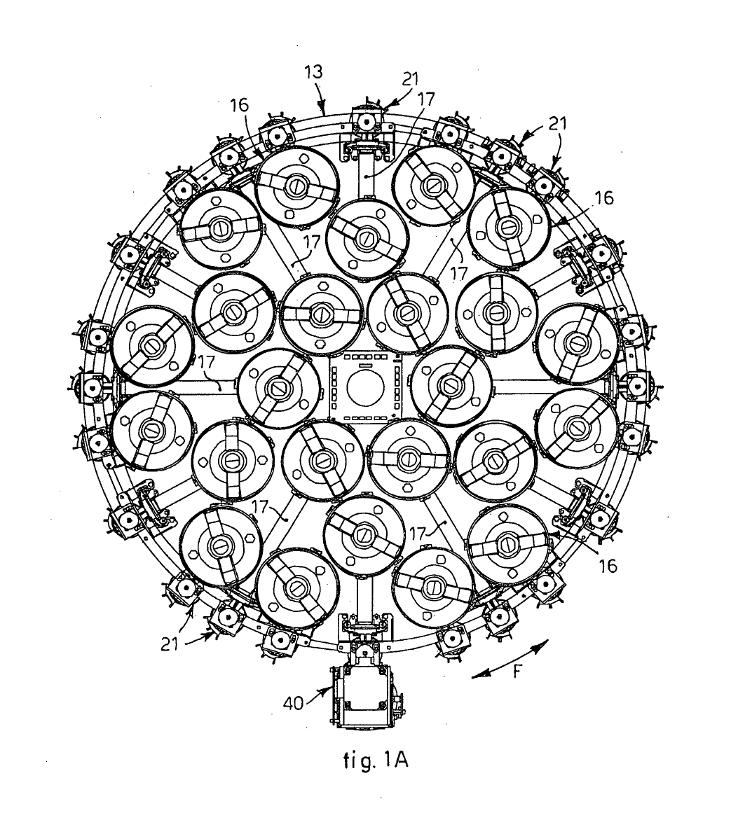

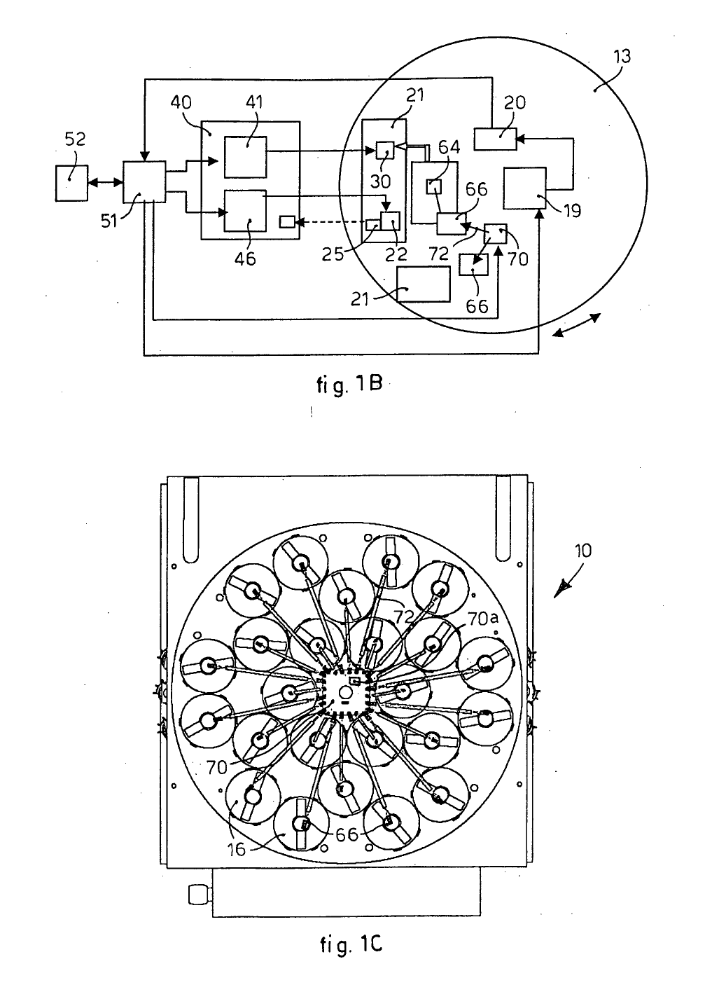

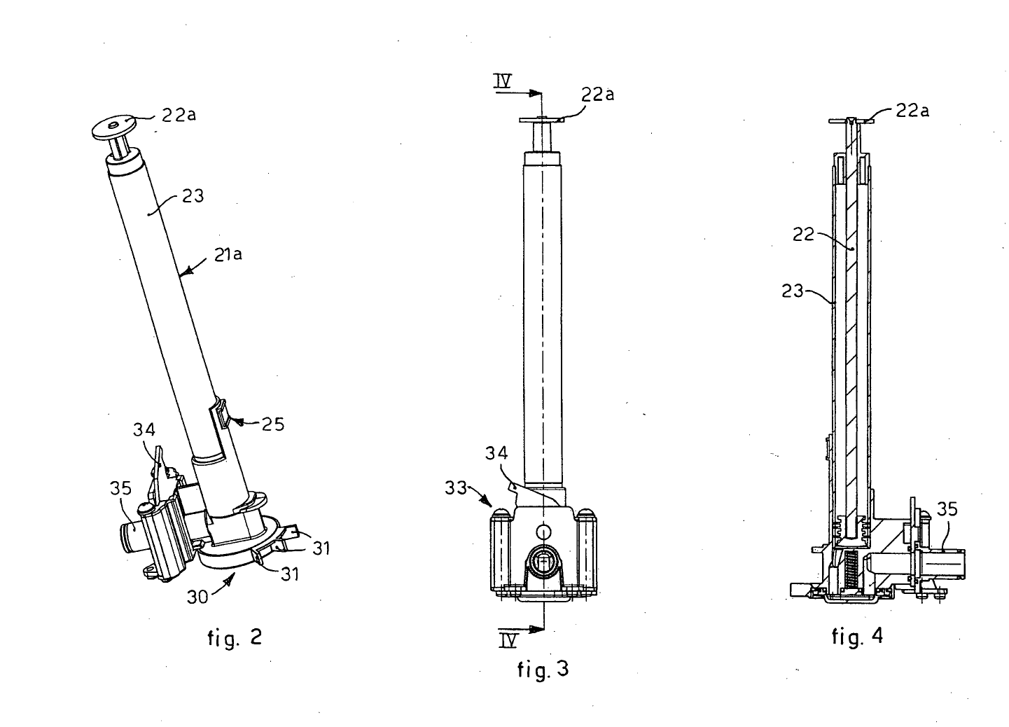

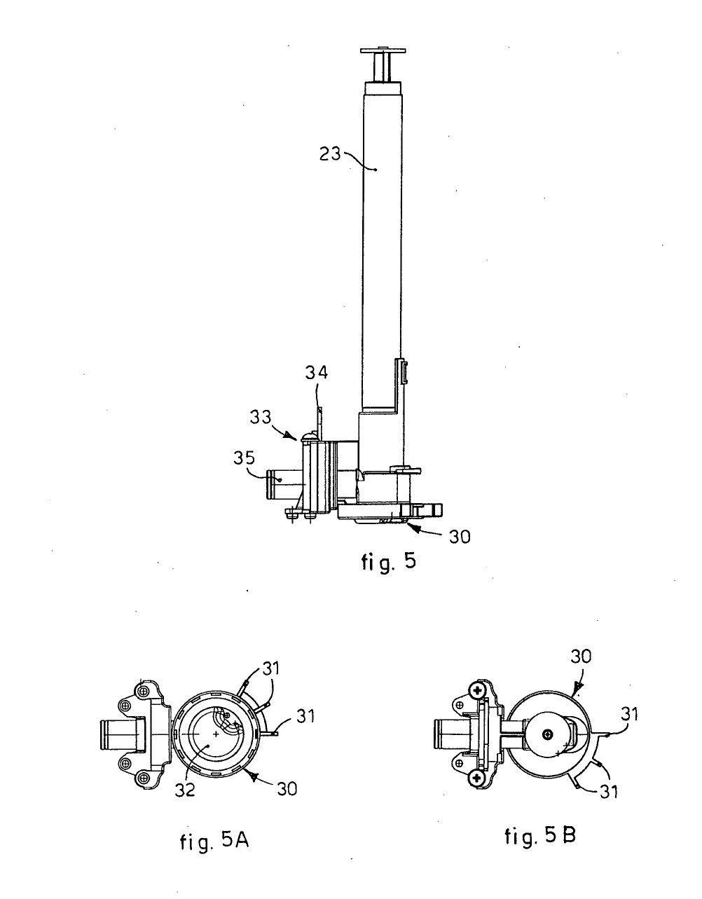

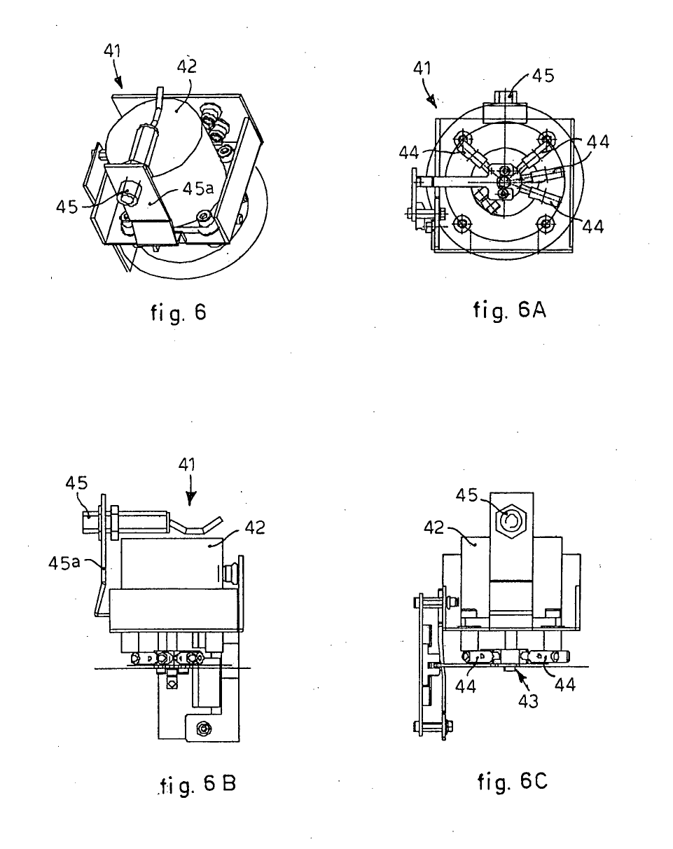

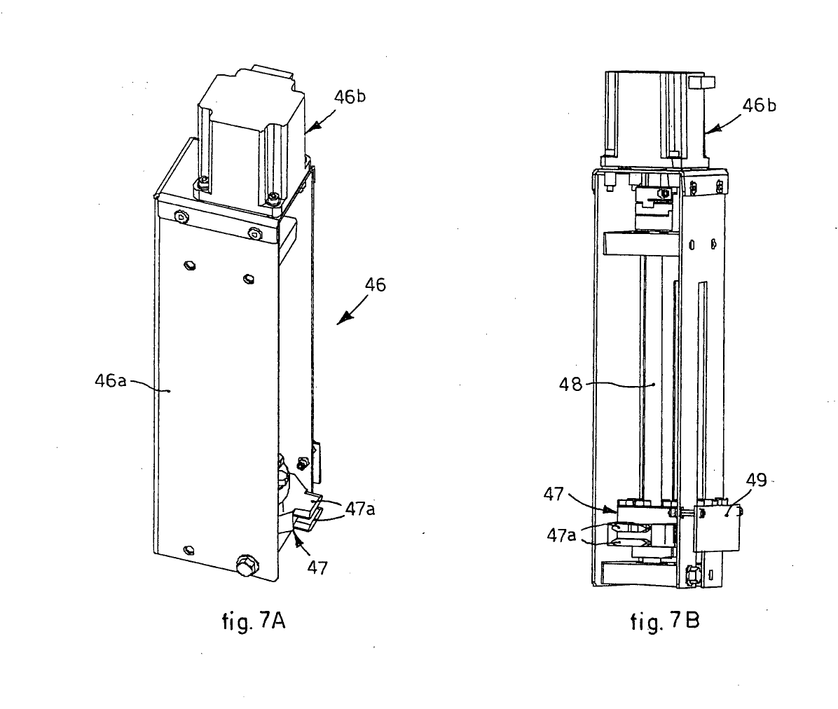

The pistons 21a to deliver the colorant are provided with a corresponding cylinder 23 (FIGS. 2-5B), a plunger 22, mobile linearly inside the cylinder 23. The plunger 22 is provided at an upper end with a head 22, which protrudes from the cylinder 23 and is suitable to cooperate operatively with the actuation unit 40 in order to deliver the colorant by means of pumping.

Each piston 21a is associated with a corresponding delivery valve 30 disposed at a lower end of the piston 21a, hydraulically connected to the cylinder 23 and able to be selectively activated to intercept the flow of colorant.

The delivery valve 30 is of the disk type with three positions, and comprises a rotatable ring nut, solid with a disk type faucet 32 of the valve, provided with three attachment teeth 31 that protrude radially from the ring nut. The teeth 31 are angularly distanced in a manner coherent with the operating positions of the valve 30 as described below. The attachment teeth 31 are able to cooperate with the actuation unit 40 so as to allow the rotation of the disk and thus activate, or switch, the valve 30 between several operating positions.

In this case the valve 30 is in a closed position, used during the movement of the rotary table 13, and in the step when the colorant is sucked up into the cylinder 23 when the dosing circuit, that is, the piston 21a, is disposed adjacent to the actuation unit 40. The valve 30 can also be switched into a first open position with a limited flow rate and a second open position with a higher flow rate, in which positions the dosing circuit 21 is disposed adjacent to the actuation unit 40.

Advantageously each valve 30 is also provided with mechanical end-of-travel stops, suitable to prevent the rotation of the disk type faucet 32 in unwanted positions.

The lower end of the piston 21 a is also stably coupled with an attachment element 33 provided with a sleeve 35 for connection to a corresponding pipe 17 and with a release lever 34. The lever 34 allows to remove the piston 21a from its attachment seating on the table 13, for example for maintenance requirements, at the same time closing the sleeve 35, thus preventing any possible leakages of residual colorant when the piston 21a is removed.

The piston 21a is also provided with a metal tongue 25, mounted on a lateral surface thereof, substantially facing toward the outside of the rotary table 13 so as to be facing toward the actuation unit 40 when it is disposed in correspondence with the actuation unit. The tongue 25 is able to cooperate with a proximity sensor 45 connected to the control and processing unit 51, as will be described in more detail hereafter, so as to drive the rotation of the table 13 by means of said motor, provided with a bidirectional position encoder 20, to position a predetermined dosing circuit 21 in correspondence with the actuation unit 40.

Advantageously at least one tongue 25 has transverse sizes that are different from the other tongues 25, so as to allow to identify a predetermined piston 21a and therefore a corresponding reference position. The piston 21a is assigned a number that identifies it univocally, starting for example from number one. The remaining pistons 21a are identified with different identification numbers, for example by progressively increasing the identification numbers of the other pistons 21a recognized by the sensor 45.

The actuation unit 40 (FIG. 1) is operatively positioned, as will be described hereafter, on a front part of the frame 12, substantially in a median position, and comprises a first 41 and a second actuator 46. The first actuator 41 comprises a compound lever unit driven for example by a step motor 42, in turn commanded by the control and processing unit 51. The compound lever unit is provided with a rotary actuation joint 43 having horizontal lever elements 44 that protrude radially with respect to a substantially vertical axis of rotation. The lever elements 44 are disposed angularly in a manner coherent with the teeth 31 of the valve 30. In fact, the actuation joint 43 is suitable to cooperate, by means of the lever elements 44, with the teeth 31 of the valve 30 when the piston 21 a is disposed adjacent to the actuation unit 40, to command the activation of the valve between its operating positions.

The first actuator 41 is also associated with a proximity sensor 45, such as for example an inductive sensor, connected to the control and processing unit 51 and mounted on a support plate 45a so as to face toward the rotary table 13. The sensor 45 is able to cooperate with the tongues 25 of the pistons 21a so as to allow to detect, during the rotation of the table 13, the alignment of the first actuator 41 and a corresponding piston 21a.

The second actuator 46, substantially aligned with the first actuator 41 in a position above it, comprises a container 46a, shaped like an elongated parallelepiped, open on one side. The actuator 46 comprises a step motor 46b, attached above the frame 46a, and suitable to move linearly a slider 47 along part of the height of the frame 46a.

The slider 47 is suitable to move, in turn, the plunger 22 of a piston 21a disposed adjacent to the actuation unit 40. The slider 47 is mechanically coupled with a worm screw 48 that develops along the height of the frame 46a, in turn coupled at an upper end with the step motor 46b. The slider 47 comprises two horizontal protuberances 47a, able to cooperate operatively, during the movement of the slider 47, with the head 22a of the plunger 22, in order to take in/deliver colorant into/from the piston. A detection card 49 is also attached to the container 46a, and is able to detect a reference position, or zero position, of the slider 47. According to a preferential embodiment, the card 49 comprises an optical type detector able to detect, through a groove 49a in a wall of the container 46a, a reference element of the slider 47.

Advantageously, the command board 50 is hinged to the support frame 12 and is mobile between at least an open position to allow maintenance to the device, and a closed operating position. The first actuator 41 and the second actuator are mounted on the command board 51 so as to be adjacent to at least one delivery unit 21 positioned in the delivery seating when the command board 50 is disposed in the closed position.

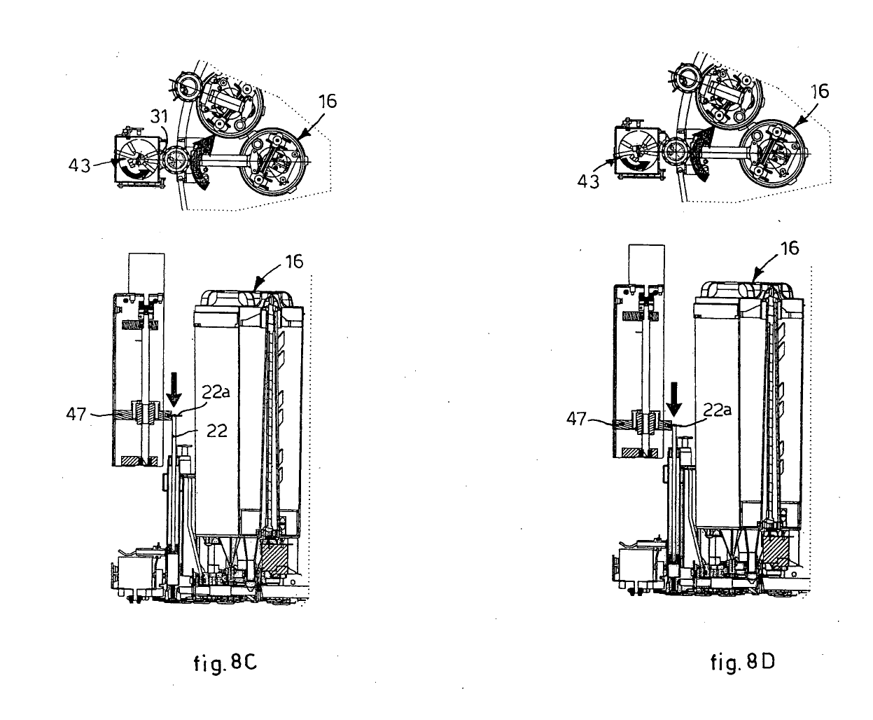

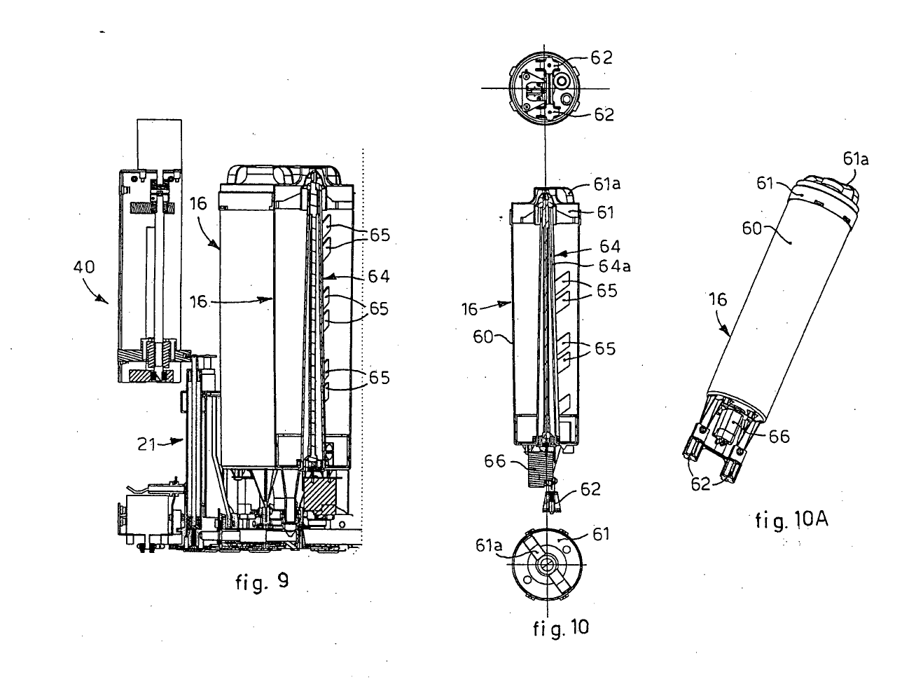

Each canister 16 (FIGS. 9-10A) comprises a container 60 provided with a lid 61 to close its upper end, able to be driven by means of a handle 61a so as to effect filling operations and transfer the colorant inside it. The container 60 is also provided, at a lower end, with columns 62 to attach the canister 16, suitable to be inserted into suitable seatings of the table 13 so as to hold each canister 16 firmly in a substantially vertical operating position.

The stirrer 64 is disposed inside the container 60, and comprises an oblong rod 64a disposed axially along the height of the canister 16. The rod 64a is provided with stirrer blades 65 suitable to mix the colorant contained in the canister 16. The blades 65 are substantially flat or with a slightly curvilinear profile and protrude radially from the rod 64a, uniformly along its longitudinal development. The rod 64a is suitable to rotate axially, according to an axis of rotation that is substantially parallel to the axis of rotation X of the rotary table 13.

The canister 16 is also provided with a direct current motor 66, mounted on a lower end of the container 60. The motor 66 is mechanically connected to the rod 64 so as to drive its rotation.

The device 10 also comprises an electronic card 70, attached to the rotary table 13, substantially in a central position, and electrically connected both to the control and processing unit 51 and also to a source of electric power, in a known manner, for example by means of sliding contacts disposed in the lower part of the table 13.

The electronic card 70 is provided with a plurality of electric connectors 71, each suitable to be connected by an electric feed cable 72 to an associated motor 66 of a canister 16. Advantageously the electronic card 70 is provided with a micro-processor unit 70a, having digital outputs that are independently drivable and connected, directly or indirectly, to said connectors 71.

The delivery device 10 as described heretofore functions as follows.

After positioning a container in the tray 56 of the dispensing seating, the control and processing unit 51, according to the type of formula or composition of colorant to be obtained, and therefore according to a specific sequence of doses taken from a predetermined group of canisters among those available on the table 13, activates the rotation of the table 13 until, by means of the proximity sensor 45, the piston 21a required in the specific formula or composition is identified.

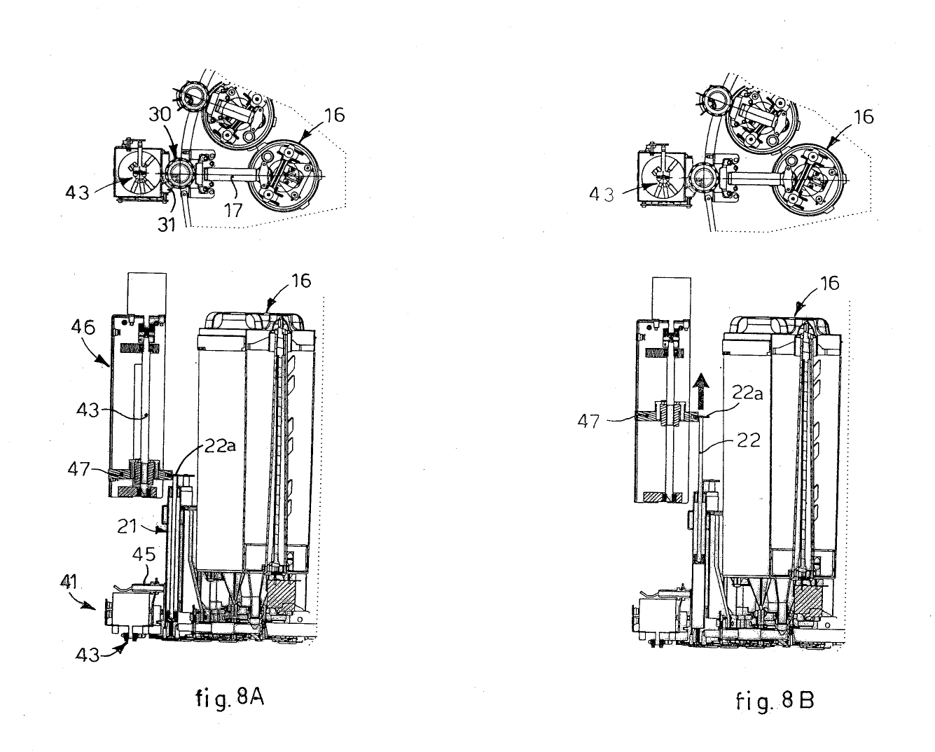

The control and processing unit 51 rotates the table 13, continuously detecting its position with respect to the reference position by means of the bidirectional encoder 20, until it disposes the piston 21a relating to the first colorant to be dosed in correspondence with the dispensing seating. This condition is detected when the proximity sensor 45 aligns with the tongue 25 of said piston 21a. In the dispensing position the head 22a of the plunger 22 is disposed between the protuberances 47a of the slider 47 of the second actuator 46 (FIG. 8A).

It is also advantageously possible to define a procedure able to recognize the number of delivery units 21 present and mounted and their position with respect to a specific reference unit 21. The table 13 is driven in a predetermined direction of travel, for example clockwise, and for every delivery unit 21 present, detected by the proximity sensor 45, the distance in encoder steps is read, starting from the first unit 21 found and the size of its tongue 25.

When the table has made a complete turn, the presence is also detected of the reference delivery unit 21 and consequently all the distances in encoder steps of the remaining delivery units 21 from the specific reference delivery unit are calculated and memorized.

Advantageously the control and processing unit 51 is connected to a memorization unit 52 in which at least a configuration table is memorized, which identifies the position of each piston 21a on the table 13 and the specific colorants contained therein. The configuration table can be modified according to possible variations and/or replacements of canisters 16 having different colorants.

During the rotation of the table 13, all the valves 30 are disposed in their inactive position in which the teeth 31 are disposed so as not to interfere mechanically with the lever elements 44 of the compound lever unit of the second actuator 46.

Subsequently the control and processing unit 51 switches the valve into its closed position, driving the motor 42 of the first actuator 41. This causes the rotation of the actuation joint 43 so as to make a first of said lever elements 44 contact one of the teeth 31 of the valve 30, producing the rotation of the disk type faucet 32.

Then an intake step is activated (FIG. 8B) in which the colorant is taken from the corresponding canister 16 by means of the pipe 17 and transferred inside the piston 21a. In this step the plunger 22, in an initial inactive step, that is, disposed completely inside the cylinder 23, is lifted by means of the second actuator 46 to a predetermined loading position. This position corresponds to the intake of a quantity of desired colorant so as to obtain the desired composition.

In this case, the control and processing unit 51 activates for example the step motor 46b for a number of steps sufficient to move the slider 47 by means of the screw 48 to the desired position. In turn the slider 47 intercepts the head 22a of the plunger 22 by means of the lower protuberance 47a and causes it to be lifted.

At the end of the intake step, a pre-delivery step is carried out in which the control and processing unit 51 inverts the direction of rotation of the step motor 46b and therefore the direction of movement of the slider 47, displacing the plunger 22 downward by a predetermined height, keeping the delivery valve 30 closed. This allows to obtain an optimum pressure condition inside the piston 21a for the subsequent delivery of the colorant.

When the plunger 22 has stopped moving, the control and processing unit 51 switches the valve into one of the two open positions, depending on the flow rate (FIGS. 8B and 8C), driving for example the motor of the first actuator 41. This leads to the rotation of the actuation joint 43 so as to make a second and/or a third of said lever elements 44 contact the teeth of the valve 30, rotating the disk faucet 32 of the valve 30 until it is open. The selection of one of the two positions, respectively with a greater or lesser flow rate, is carried out according to the quantity of colorant to be delivered, which is in turn directly proportional to the speed of movement of the plunger.

Subsequently the delivery step is effected, in which the control and processing unit 51 moves the slider 47 downward, as previously described, delivering the colorant through a hole of the disk type faucet 32 into the container below.

When the delivery step is finished, the control and processing unit 51 switches the valve 30 to its closed position, rotating the actuation joint 43 as described above so as to make the lever elements 44 contact the teeth 31 of the valve 30, producing the rotation of the disk faucet 32 to its closed position and the first actuator 41 to its inactive position.

Then the control and processing unit 51 activates the rotation of the rotary table 13 so as to position in the dispensing seating the piston 21a corresponding to the next colorant to be delivered. The rotation of the table 13 is accurately controlled by the control and processing unit 51, according to the information arriving from the encoder 20 and to the detection of the position of each piston 21a, provided by the sensor 25 together with the information to configure the disposition and content of the canisters 16 as memorized in the memorization unit 52.

Advantageously the control and processing unit 51, in correspondence with each individual delivery, regulates the rotation of the table 13 in the two directions of rotation, clockwise and anticlockwise, so as to minimize the total travel, that is, the absolute angle of rotation obtained as the sum of the individual angles of rotation of the table 13 during the delivery sequence of the final composition or formula. Since the speed of rotation of the table 13 is substantially constant, this allows to considerably reduce the overall delivery times, given the same formula sequence, compared with devices that always rotate in the same direction of rotation.

The optimization of the rotation sequences corresponding to the delivery sequences is effected according to the number of encoder impulses detected by the control and processing unit 51.

During the functioning of the device 10, that is, both during the rotation of the table 13 and also during the dispensing of the colorant, the control and processing unit 51, by means of the microprocessor unit 70a, selectively activates, independently of the movement of the rotary support and/or its direction of rotation, one or more stirrers 64, driving the corresponding motors 66, so as to keep the colorant contained therein in good conditions of preservation.

It is understood that the drive of the stirrers 64 can be carried out by driving the corresponding motors 66 according to predetermined or variable groupings. According to another solution it is possible to define predetermined groupings of canisters 16, in which a corresponding motor is associated with each grouping and is suitable to transmit, by means of associated transmission kinematisms, the rotation motion to all the stirrers 64 of the grouping.

The stirrers 64 are driven continuously or periodically, with predetermined or variable durations of stirring depending on the type of colorant contained in each canister 16 and/or a predetermined delivery sequence to be carried out.

In this way it is possible to mix the fluid contained in each container when actually desired, according to the type of fluid contained, not only during the movement of the rotary support, as happens in the state of the art, but also during the delivery of fluid or during periods of inactivity of the device.

According to a preferential solution, when the device 10 is switched on, or after any maintenance, such as the replacement of one or more delivery units 21, an initialization step is performed in which the slider 47 is taken to an upper position, substantially at its upper end-of-travel. The table 13 is rotated to take a piston 21a to the delivery seating. The slider 47 is lowered, and by means of a thrust exerted by the lower protuberance 47a of the slider 47 on the head 22a, the plunger 22 is lowered until the lower end-of-travel is reached. The delivery valve 30 is closed and the actuation joint 43 is taken to an inactive position. Subsequently, the slider 47 is returned to the upper end-of-travel.

These operations are performed for all the pistons 21a present.

When this step is finished in which all the plungers 22 are at a lower mechanical abutment, the table 13 is rotated so as to free from the delivery zone any piston 21a possibly fouled and the slider 47 is taken to the ideal position so as to attach the head 22a of the plunger 22.

It is clear that modifications and/or additions of parts and/or steps may be made to the delivery device 10 and the relative method as described heretofore, without departing from the field and scope of the present invention.

For example, it comes within the field of the present invention to provide that the device is provided with a device to clean the valve 30, able to clean, during the rotation of the table 13, any residual colorant from the lower surface of each valve 30. This allows to keep the device 10 always in efficient conditions, reducing maintenance operations to a minimum.

It is also clear that, although the present invention has been described with reference to some specific examples, a person of skill in the art shall certainly be able to achieve many other equivalent forms of delivery device and the relative method, having the characteristics as set forth in the claims and hence all coming within the field of protection defined thereby.

1. A delivery device for fluid products comprising:
a plurality of containers, each able to contain a predetermined fluid and connected to an associated delivery unit provided with a piston unit comprising a cylinder and a plunger linearly movable inside said cylinder,
a support on which said plurality of containers is mounted, able to rotate to position sequentially, at different moments of time according to one or more predetermined sequences, at least some of said delivery units in a predetermined delivery seating, to deliver corresponding quantities of fluid to obtain a desired fluid composition,
each delivery unit being provided with at least a disk type delivery valve disposed at a lower end of said piston,
said valve being provided with actuation teeth and being activatable between at least two distinct open conditions and a closed condition,
the delivery unit comprising a first actuator provided with lever elements suitable to cooperate with said teeth of the valve to command the activation of the valve between the operating positions of the valve, and a second actuator, substantially aligned with, and in a position above, said first actuator, suitable to move a head of said plunger to raise and lower the plunger coordinately with the movement of said valve in the open or close position.

2. (canceled)

3. The delivery device as in claim 1, wherein each of said disk type delivery valves has at least a first delivery position with a greater flow rate, a second delivery position with a lower flow rate and a third closed position.

4. The delivery device as in claim 1, wherein said disk type delivery valves are made of ceramic material.

5. The delivery device as in claim 1, wherein the rotary support is movable in two opposite directions of rotation to position, according to one or more predetermined delivery sequences, the delivery units in the delivery seating to minimize the absolute angle of rotation of the support during the delivery sequence.

6. The delivery device as in claim 1, wherein the first actuator is able to assume an inactive position in which they do not interfere mechanically with the delivery valves during the rotation of the support.

7. The delivery device as in claim 1, wherein the second actuator comprises a slider, mobile linearly and driven by a step motor.

8. The delivery device as in claim 1, comprising a command board, connected to a supporting and containing frame, mobile between at least an open position for the maintenance of the device and a closed operative position, and wherein the first and second actuation means are associated with said command board so as to be adjacent with at least one delivery unit positioned in the delivery seating, when the command board is disposed in the closed position.

9. The delivery device as in claim 1, comprising detection means, associated with the delivery seating, able to detect, during the rotation of the support, the position of each delivery unit in proximity with said delivery seating.

10. The delivery device as in claim 1, comprising stirrer means, associated with the containers and able to mix the fluids contained in the containers, at least some of said stirrer means being selectively activatable, independently of each other.

11. The delivery device as in claim 10, wherein the stirrer means are selectively activatable independently of the movement of the support and/or its direction of rotation.

12. A method to deliver fluid products comprising:
providing a plurality of containers, each able to contain a predetermined fluid and connected to an associated delivery unit provided with a piston unit, and a rotary support on which said plurality of containers is mounted,
said rotary support positioning sequentially at least some of said delivery units, at different moments of time according to one or more predetermined sequences, in a predetermined delivery seating, to deliver corresponding quantities of fluid to obtain a desired fluid composition,
wherein at least two distinct open conditions and a closed condition can be activated by acting on a disk type delivery valve, and wherein a first actuator provided with lever elements cooperates with teeth of said valve to command the activation of the valve between the operating positions of the valve, and a second actuator, substantially aligned with, and in a position above, said first actuator, moves a head of said plunger to raise and lower the plunger coordinately with the movement of said valve in the open or close positions.

13. The method as in claim 12, wherein a selected delivery unit positioned in the delivery seating is driven by actuation means suitable to cooperate with the piston unit and with the corresponding disk type delivery valve.

14. The method as in claim 12, wherein each of said disk type delivery valves is switchable between at least a first delivery position with a greater flow rate, a second delivery position with a lower flow rate and a third closed position.

15. The method as in claim 13, wherein during the rotation of the support the first actuation means assume an inactive position in which they do not interfere mechanically with the delivery valves during the rotation of the support.

16. The method as in claim 12, wherein the support is moved in two opposite directions of rotation to position, according to one or more predetermined delivery sequences, the delivery units in the delivery seating to minimize the absolute angle of rotation of the support during the delivery sequence.

17. The method as in claim 12, wherein during the rotation of the support, detection means detects the position of each delivery unit in proximity with said delivery seating.

18. The method as in claim 12, comprising:
an intake step in which the colorant is taken into the piston unit,
a subsequent step of pre-delivery in which the piston unit is compressed, keeping the disk type delivery valve in the closed position, and
a subsequent step of delivery in which the disk type delivery valve is switched into one of the open positions and the piston unit is compressed to deliver the colorant.

19. The method as in claim 12, comprising a step in which detection means control the presence of the delivery units mounted on the support and the corresponding position with respect to a specific reference delivery unit.

20. The delivery device as in claim 7, wherein said slider is mechanically coupled with a worm screw that develops along the height of a frame of said second actuator, said worm screw being in turn coupled at an upper end with said step motor.
